(19) United States
(12) Patent Application Publication
(10) Pub. No.: US 2026/0107167 A1
(43) Pub. Date: Apr. 16, 2026

(54) TECHNIQUES FOR CONTROL CHANNEL DESIGN

(71) Applicant: Lenovo (United States) Inc., Morrisville, NC (US)

(72) Inventors: Hossein Bagheri, Dearborn Heights, MI (US); Vijay Nangia, Woodridge, IL (US); Karthikeyan Ganesan, Kronberg im Taunus (DE)

(21) Appl. No.: 18/913,745

(22) Filed: Oct. 11, 2024

(51) Int. Cl. H04W 24/08; H04L 5/00; H04W 72/23

(52) U.S. Cl. CPC H04W 24/08; H04L 5/005; H04W 72/23

(57) ABSTRACT

Various aspects of the present disclosure relate to techniques for control channel design. A user equipment (UE) may be configured to determine a set of resource block (RB) offsets associated with a synchronization signal block (SSB), wherein the set of RB offsets include at least two RB offsets. The UE may be configured to select at least one of the two RB offsets based on one or more criteria. The UE may be configured to determine resources for monitoring control channel candidates based on the selected at least one of the two RB offsets, and monitor control channel candidates based on the determined resources.

### TECHNICAL FIELD

The present disclosure relates to wireless communications, and more specifically to techniques (e.g., methods, designs) for control channel monitoring.

### BACKGROUND

A wireless communications system may include one or multiple network communication devices, such as base stations, which may support wireless communications for one or multiple user communication devices, which may be otherwise known as UE, or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

A UE for wireless communication is described. The UE may be configured to, capable of, or operable to determine a plurality of resource block (RB) offsets associated with a synchronization signal block (SSB), wherein the plurality of RB offsets comprises at least two RB offsets; select at least one of the two RB offsets based on one or more criteria; determine resources for monitoring control channel candidates based on the selected at least one of the two RB offsets; and monitor control channel candidates based on the determined resources.

A method for wireless communication performed by a UE. The method may include determining a plurality of RB offsets associated with a SSB, wherein the plurality of RB offsets comprises at least two RB offsets; selecting at least one of the two RB offsets based on one or more criteria; determining resources for monitoring control channel candidates based on the selected at least one of the two RB offsets; and monitoring control channel candidates based on the determined resources.

A processor for wireless communication is described. The processor may be configured to, capable of, or operable to determine a plurality of RB offsets associated with a SSB, wherein the plurality of RB offsets comprises at least two RB offsets; select at least one of the two RB offsets based on one or more criteria; determine resources for monitoring control channel candidates based on the selected at least one of the two RB offsets; and monitor control channel candidates based on the determined resources.

Another UE for wireless communication is described. The UE may be configured to, capable of, or operable to receive a message comprising a set of fields, wherein a first field of the set of fields indicates a first set of resources, wherein a second field of the set of fields indicates a second set of resources, and wherein the second set of resources is a subset of the first set of resources; determine non-overlapping resources of the first set of resources and the second sets of resources; determine a set of control channel elements based on the determined non-overlapping resources; and monitor the determined set of control channel elements.

Another method for wireless communication performed by another UE. The method may include receiving a message comprising a set of fields, wherein a first field of the set of fields indicates a first set of resources, wherein a second field of the set of fields indicates a second set of resources, and wherein the second set of resources is a subset of the first set of resources; determining non-overlapping resources of the first set of resources and the second sets of resources; determining a set of control channel elements based on the determined non-overlapping resources; and monitoring the determined set of control channel elements.

Another processor for wireless communication is described. The processor may be configured to, capable of, or operable to receive a message comprising a set of fields, wherein a first field of the set of fields indicates a first set of resources, wherein a second field of the set of fields indicates a second set of resources, and wherein the second set of resources is a subset of the first set of resources; determine non-overlapping resources of the first set of resources and the second sets of resources; determine a set of control channel elements based on the determined non-overlapping resources; and monitor the determined set of control channel elements.

### BRIEF DESCRIPTION OF THE DRAWINGS

FIG. 1 illustrates an example of a wireless communications system in accordance with aspects of the present disclosure.

FIG. 2 illustrates an example of an SSB structure in accordance with aspects of the present disclosure.

FIG. 3 illustrates an example of a bandwidth part (BWP) operation in accordance with aspects of the present disclosure.

FIG. 4 illustrates an example of an inter-control resource set (CORESET) offset in accordance with aspects of the present disclosure.

FIG. 5A illustrates an example of a low power wide area (LPWA) UE operation in accordance with aspects of the present disclosure.

FIG. 5B illustrates an example of an LPWA UE operation in accordance with aspects of the present disclosure.

FIG. 6 illustrates an example of control channel candidates in a CORESET in accordance with aspects of the present disclosure.

FIG. 7 illustrates an example of a resource collision in accordance with aspects of the present disclosure.

FIG. 8 illustrates an example of a CORESET for LPWA-UE in accordance with aspects of the present disclosure.

FIG. 9 illustrates an example of control channel element (CCE) to resource element group (REG) mapping in accordance with aspects of the present disclosure.

FIG. 10 illustrates an example of a user equipment (UE) in accordance with aspects of the present disclosure.

FIG. 11 illustrates an example of a processor in accordance with aspects of the present disclosure.

FIG. 12 illustrates an example of a network equipment in accordance with aspects of the present disclosure.

FIG. 13 illustrates a flowchart of method in accordance with aspects of the present disclosure.

FIG. 14 illustrates a flowcharts of method in accordance with aspects of the present disclosure.

### DETAILED DESCRIPTION

A wireless communication system may support LPWA communications to support Internet of Things (IoT) by enabling low-power devices, such as IoT devices, Narrowband IoT (NB-IoT) devices, and Ambient-IoT (A-IoT devices), to perform operations (e.g., transmitting, receiving, processing, among other operations) with minimal power consumption. The power consumption for operations such as digital baseband processing may scale with bandwidth. Some devices may be operable of or configured to operate with limited bandwidth to maintain low power consumption. Therefore, it may be desired to establish a unified framework and signaling protocol for devices supporting and deployed in wireless communication systems that support radio access technologies beyond 5G (e.g., 5G-Advanced, 6G). For example, broadcast signaling may provide essential information, such as control channel monitoring, before random access can occur (e.g., similar to a Master Information Block (MIB) in 5G New Radio (NR)). This information can be utilized by both LPWA UE (LPWA-UE) and non-LPWA UE (non-LPWA UE).

Various aspects of the present disclosure enable UEs (e.g., LPWA UEs, non-LPWA UEs) to determine resources for monitoring a control channel (e.g., a physical downlink control channel (PDCCH)), prior to random access (e.g., similar to CORESET 0 in 5G NR), based on receiving a same broadcast signal. The determined resources may be different for the UEs, for example, resources for LPWA UEs may be different from resources for non-LPWA UEs. That is, a greater number of resources may be provided (e.g., allocated, scheduled, assigned) for control channel monitoring to the non-LPWA UEs and a fewer number of resources may be provided (e.g., allocated, scheduled, assigned) for control channel monitoring to the LPWA UEs. In one embodiment, the subject matter herein discloses solutions that conserve UE power and provide for more efficient utilization of resources due to the enhanced monitoring of control channels.

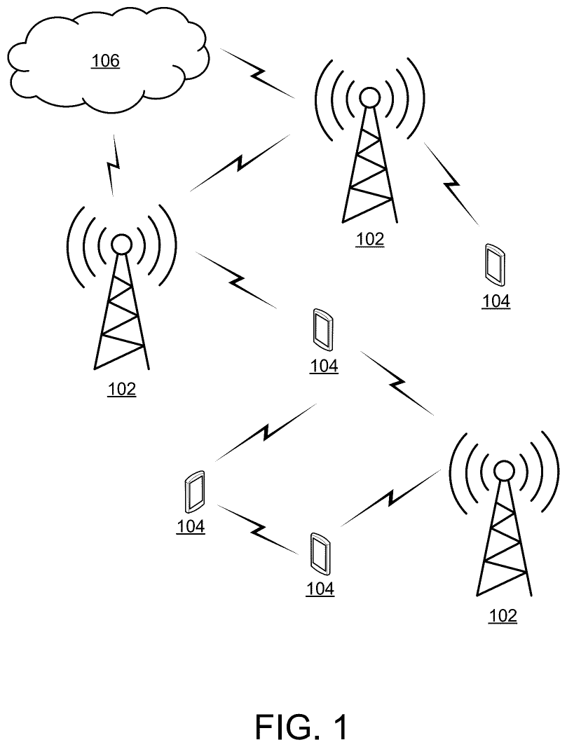

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0,μ=1,μ=2, μ=3,μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively.

Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In one embodiment, control channel information (e.g., downlink control information (DCI)) is carried by a physical downlink control channel (PDCCH) in 5G. The DCI bits (after procedures such as cyclic redundancy check (CRC) attachment, radio network temporary identifier (RNTI) masking, interleaving, polar encoding, sub-block interleaving, rate-matching, scrambling, Quadrature Phase Shift Keying (QPSK) modulation, or the like) are mapped to resource element groups (REGs), where 6 REGs are mapped to a CCE and a REG spans 1 resource block (RB) in one symbol. Nine REs of a REG contain PDCCH payload, and 3 REs contain demodulation reference signal (DMRS).

A UE performs blind detection/decoding of control channel candidates of a PDCCH monitoring occasion of a search space set where each PDCCH candidate comprises one or multiple CCEs (also known as aggregation level (AL), with possible values such as 1, 2, 4, 8, 16). A PDCCH with AL ‘L’ comprises ‘L’ contiguous CCEs. In one embodiment, associated REGs can be in non-contiguous positions. The associated REGs belong to a CORESET. There are two types of CCE-to-REG mapping: interleaved and non-interleaved. In the case of interleaved mapping, each CCE is composed of one or more REG bundles that are distributed in the frequency domain in units of REG bundles. A REG bundle is a set of indivisible resources consisting of neighboring REGs. A REG bundle spans across orthogonal frequency division multiplexing (OFDM) symbols for the given CORESET. For non-interleaved CCE-to-REG mapping, all CCEs of a PDCCH with AL ‘L’ are mapped in consecutive REG bundles of the CORESET.

The resources for the CORESET are configured by RRC signaling except for CORESET 0. PDCCH can be precoded in a wideband manner or a narrowband manner. In wideband precoding, PDCCH DMRSs are transmitted in all contiguous REGs of a CORESET carrying the PDCCH using the same precoder. However, in narrow-band precoding, DMRS REs are transmitted only in the REG bundles actually used for the PDCCH transmission, and precoding is constant only within the REG bundle.

CORESET 0 is a special CORESET which carries PDCCH/DCI for SIB1. The time-frequency resource of CORESET 0 is indicated by MIB which is carried by physical broadcast channel (PBCH) (as part of a SSB). In 5G NR, CORESET 0 can have 24 or 48 RBs and 1-3 symbols in FR1.

According to TS 38.213 (incorporated herein by reference), for operation without shared spectrum channel access, a UE assumes that an offset (in tables 13-0 through 13-10A in TS 38.213) is defined with respect to the subcarrier spacing (SCS) of the CORESET for Type0-PDCCH common search space (CSS) set from the smallest RB index of the CORESET for Type0-PDCCH CSS set to the smallest RB index of the common RB overlapping with the first RB of the corresponding SS/PBCH block, after puncturing if any (see TS 38.211, incorporated herein by reference). The SCS of the CORESET for Type0-PDCCH CSS set is provided by subCarrierSpacingCommon for FR1. The SSB_Subcarrier Offset in MIB indicates N\hat{ }{SSB}_{CRB}, and one of the tables (e.g., 13-1 to 13-10 in 38.213), defines the offset. For CORESET 0, the UE may assume interleaved CCE-to-REG mapping, a REG bundle size of 6 RBs, and an interleaved size of 2.

Monitoring many PDCCH candidates or performing channel estimation on many CCEs increases the UE complexity. Currently, PDCCH monitoring capability is defined as the following for a downlink (DL) BWP and a slot with a SCS configuration μ for operation with a single serving cell-a maximum number of monitored PDCCH candidates defined according to table 10.1-2 of TS 38.213 (e.g., 44 for μ=0, and 36 for μ=1) and/or a maximum number of non-overlapping CCEs that require channel estimations defined according to the table 10.1-3 of TS 38.213 (e.g., 56 for μ=0, and 56 for μ=1).

Such limitations offer reasonable UE complexity with an acceptable restriction on the configuration of search space sets for PDCCH monitoring. A similar limit is applicable for the maximum of non-overlapped CCEs (associated with PDCCH candidates). In one embodiment, the number of PDCCH candidates for Type0-PDCCH CSS set is (4, 2, 1) for AL (4, 8, 16).

For control channel in narrowband (NB)-IoT, an NCCE (Narrow-band CCE) contains 6 consecutive subcarriers spanning the entire subframe; and there are up to two NCCEs in a subframe. For DCI format 1, repetition is allowed. For control channel in machine-type communications (MTC), MTC physical downlink control channel (MPDCCH) is used, which is built on eCCEs (Enhanced CCEs) and looks similar to enhanced PDCCH (EPDCCH). MPDCCH is associated with 2 to 4 physical resource blocks (PRBs). TR 37.823 (incorporated herein by reference) discusses simultaneous operation with LTE-MTC and NR, in which there are solutions in tables 8-1 and 8-2.

The solutions concerning handling control channel overlap seem to be either of time division multiplexing (TDM) in nature (e.g., invalid subframe, multicast-broadcast single-frequency network (MBSFN) subframe, or simply putting the two control channels on different symbols) or MPDCCH in the NR PDSCH region is rate matched around.

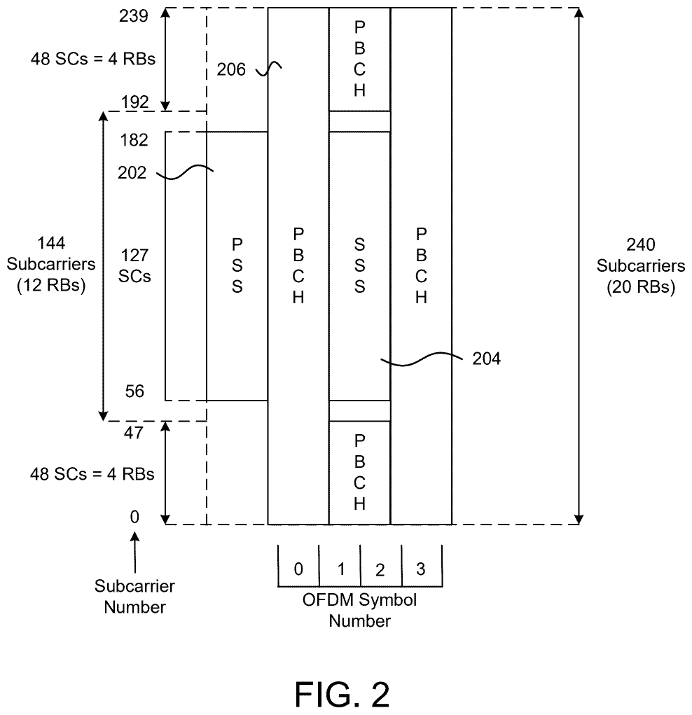

FIG. 2 illustrates an example of an SSB structure in accordance with aspects of the present disclosure. An SSB includes a primary synchronization signal (PSS) 202, secondary synchronization signal (SSS) 204, and physical broadcast channel (PBCH) 206. The SSB bandwidth is 20 RBs. After acquiring synchronization (and Cell-ID) and MIB (PBCH), the UE searches CORESET 0 (determined from the MIB) to obtain SIB1 information. The minimum number of RBs for CORESET 0 in 5G NR is 24 RBs.

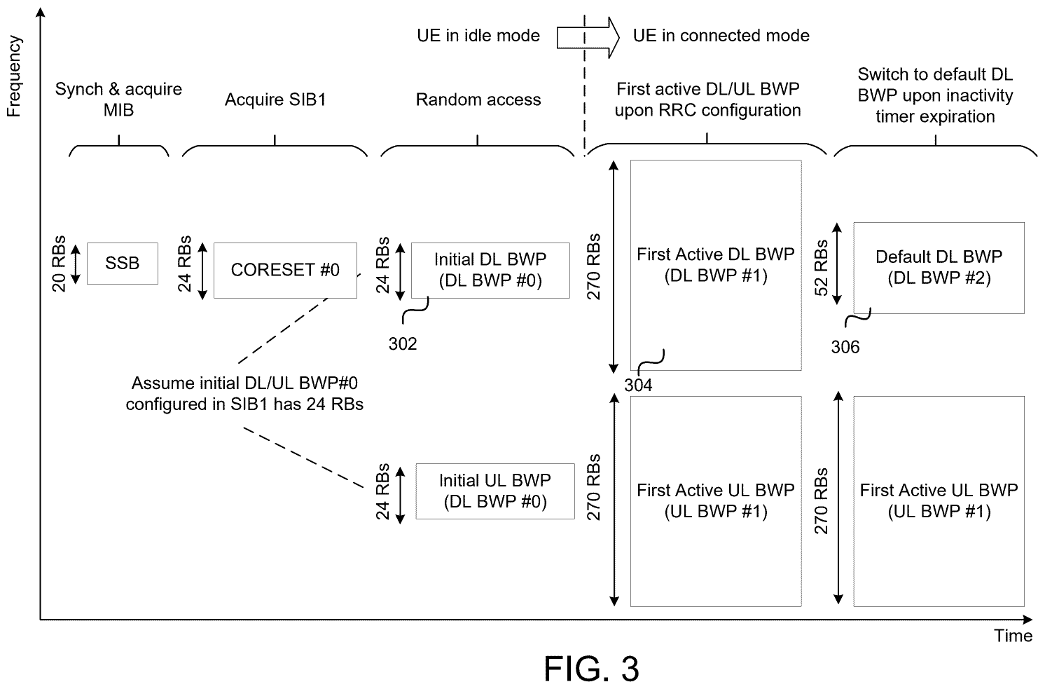

FIG. 3 illustrates an example of a bandwidth part (BWP) operation in accordance with aspects of the present disclosure. After acquiring SIB1, the UE can perform random access, and then transition to connected mode. The UE may use different BWPs throughout operation, starting from an initial BWP 302 during random access to an active BWP 304 (which can be chosen from a set of configured BWPs), and default BWP 306 when a timer expires.

Accordingly, the subject matter herein is directed to determining CORESET 0 time and frequency resources for both UE types based on one set of time frequency information (e.g., for one of the two types), determining PDCCH monitoring (e.g., in terms of CCE-to-REG mapping, number of candidates for each AL, etc.) in CORESET 0 for at least one UE type based on one set of time frequency information corresponding to the two types, and designing MIB fields to serve both UE types; including new fields (e.g., inter-CORESET 0 RB offset).

It is assumed that the LPWA UE has acquired synchronization and has decoded the PBCH and that both LPWA and non-LPWA UEs decode the same PBCH. Given its limited bandwidth, there could be several ways for an LPWA-UE to decode the same MIB as that of a non-LPWA-UE. First, the LPWA-UE uses a larger bandwidth for SSB operation (e.g., 20 RBs), and then switches back to a smaller bandwidth (e.g., 12 RBs) for the rest of operations (including for monitoring PDCCH candidates in CORESET 0). Second, the LPWA-UE collects a first part of a PBCH at a first time instance (hence using a small bandwidth), and collects a second part of a PBCH at a second time instance, and then decode the full PBCH based on the first and second parts.

CORESET 0 is a special CORESET which carries PDCCH/DCI for SIB1. The time-frequency resource of CORESET 0 is indicated by MIB which is carried by PBCH (as part of SSB). In 5G NR, CORESET 0 can have 24 or 48 RBs and 1-3 symbols in FR1 (Frequency Range 1). Based on the MIB indication, the UE not only determines the RB size and number of symbols, but also the offset RB number with respect to SSB, as well as the occurrence in time according to the corresponding search space set (for monitoring CORESET 0) determined by the MIB.

In one embodiment, a CORESET may comprise one or more control regions, where each control region comprises RBs. In one embodiment, the RB offset may be associated with a control region, e.g., a first control region, a second control region, or the like of the CORESET. Furthermore, a control region or RBs of a control regions may be identified using an index where each RB index is greater than an RB index of the starting RB of the first control region. Control regions may be monitored, or some control regions may be monitored while others are skipped, or the like.

Considering ‘X’<24 RB BW for LPWA-UE operation, either a different PBCH than the PBCH for normal (non-LPWA) UEs needs to be sent for the LPWA-UEs to determine its own CORESET 0 or the LPWA-UE needs to determine the CORESET 0 for its operation based on the same PBCH sent to the normal UEs. Such determination could be based on a mapping between the CORESET 0 of normal UEs and that of LPWA-UEs. This disclosure focuses on the latter scheme.

Although the two UE types decode the same MIB (or LPWA decodes a portion of the MIB), the RB size for the CORESET 0 of normal UEs may be larger (e.g., 48 RBs) than that of the LPWA-UEs. The LPWA-CORESET0 can be spread in time but limited to a subset of RBs indicated by the MIB. Different groups of LPWA-UEs may determine different LPWA-CORESET0 for instance, by offsetting the first RB index determined by MIB, where the offset is determined either via a preconfigured/default value (e.g., offset can be zero or a function of the SSB BW) or chosen according to a formula (e.g., taking into account the slot index) from a set of possible values. Motivation could be to put different sets of LPWA-UEs on different sets of RBs (without the need to change the BWP or retuning to a new DL frequency).

Different fields of MIB can be mapped differently for normal & LPWA UEs. For DMRS-TypeA-Position, the first symbol is used by the DMRS when using “Mapping type A”. This information element applies to the DMRS for both PUSCH and PDSCH. For LPWA, due to the limited BW, PD(U)SCH is likely more spread in time (e.g., still within a slot), it could be possible that the DMRS position can be determined by an offset to that of normal UEs or DMRS position can be distributed more in time for the LPWA and the gap between two consecutive DMRS symbols is fixed or determined based on the MIB (e.g., depending on the indicated DMRS-TypeA-Position). Alternatively, the LPWA UE uses the same DMRS position as normal UE.

For Pdcch-ConfigSIB1, LPWA-UE may only decode a subset of bits of the MIB, e.g., there could be a first MIB part (or a first PBCH part) and a second MIB part (or a second PBCH part), where the normal UE may decode both parts and the LPWA UE may decode the first part. In an example, the first part includes bit fields indicating time frequency resources of CORESET 0 of LPWA-UEs, and the second part includes bit fields indicating time frequency resources of CORESET 0 of non-LPWA-UEs, the non-LPWA-UEs determine the valid time-frequency resources, search space sets, and PDCCH candidates to monitor based on both MIB/PBCH parts (e.g., to exclude overlapping LPWA and non-LPWA CORESET resources or to determine CCE-to-REG mapping or REG bundles). In such an embodiment, there could be more bits needed for normal UEs whereas the low complexity LPWA UE may just need few bits of MIB. Another benefit could be in the case where LPWA UE detects a subset of SSB and also a subset of PBCH. For instance, the SSB bandwidth for LPWA UE is a subset (e.g., half) of that of the non-LPWA UE.

In one embodiment, LPWA-UE determines the CORESET0 parameters (including number of RBs of CORESET, the number of symbols of the CORESET, and the RB offset to determine a first/last/reference RB of the CORESET) based on a first interpretation or mapping of a value of a MIB bit-field, whereas the normal UE determines the CORESET 0 parameters based on a second interpretation or mapping of the value of the MIB bit-field.

In such an embodiment, LPWA-UE determines a first table (index of the row of the table is indicated in the MIB or determined by the MIB) from which it can determine the number of RBs for CORESET 0 (e.g., possible values can be (3, 6) RBs), the number of symbols of CORESET 0 (e.g., possible values can be (1-8) symbols or multiples of possible CORESET 0 durations for normal UEs, such as {2, 4, 6} or {3, 6, 9} symbols), and the offset RB for CORESET 0 with respect to the SSB (e.g., possible values can be (0-16) RBs).

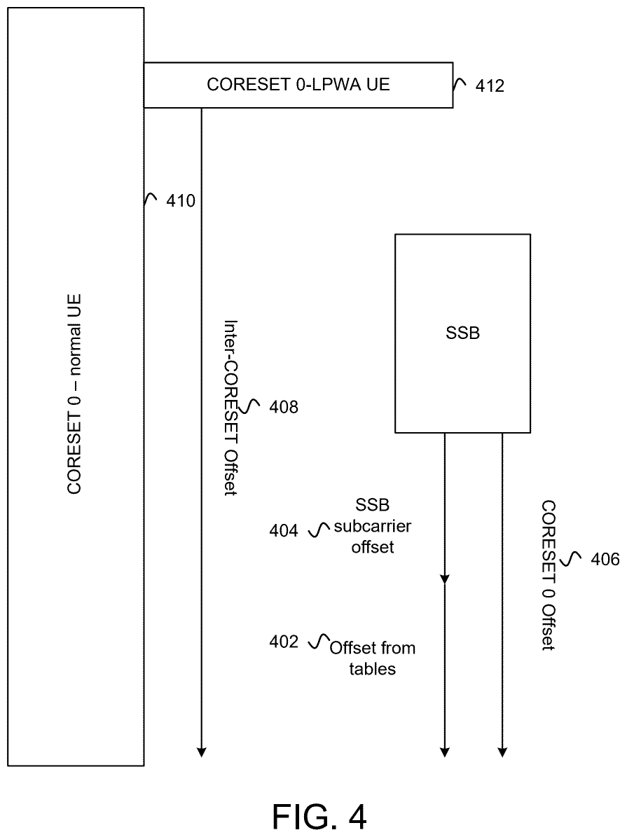

FIG. 4 illustrates an example of an inter-control resource set (CORESET) offset in accordance with aspects of the present disclosure. The inter-CORESET offset can be indicated in the second MIB part; and can be decoded by normal UEs. There could be an offset RB parameter in the MIB indication and based on the first table 402 and the offset RB parameter 404, the LPWA UE (or the non-LPWA UE) determines the actual offset with respect to the SSB 406. The offset RB parameter 404 could be selected from a list of possible values resulting in having the inter-CORESET 0 RB offset 408 be in the unit of REG bundle (e.g., when the starting RB of CORESET 0 of normal UEs 410 is aligned with boundary of REG bundles) at least when the two CORSET 0s of LPWA 412 and non-LPWA UEs 410 are overlapping.

In one embodiment, LPWA-UE determines a second table from which it can determine the number of search space sets per slot, according to a first symbol index indicating the start of the starting symbol of the search space set(s) (e.g., possible values for the first symbol can be e.g., (0-13) or (0-2) or (3-13) to do TDM (Time division Multiplexing) for control channel monitoring of corresponding CORESET 0 with non-LPWA-UE), a search space periodicity of the LPWA-UE (which may be different, e.g., multiple of that of normal UEs), and/or if the PDCCH for the LPWA-UE is repeated multiple times (e.g., spanning multiple slots), the search space periodicity of the normal UEs can be a multiple of the search space periodicity of the LPWA-UE and/or the LPWA-UE determines the number of repetitions of its PDCCH based on a field in the MIB or the number of PDCCH repetitions corresponding to CORESET 0 is specified in the specifications.

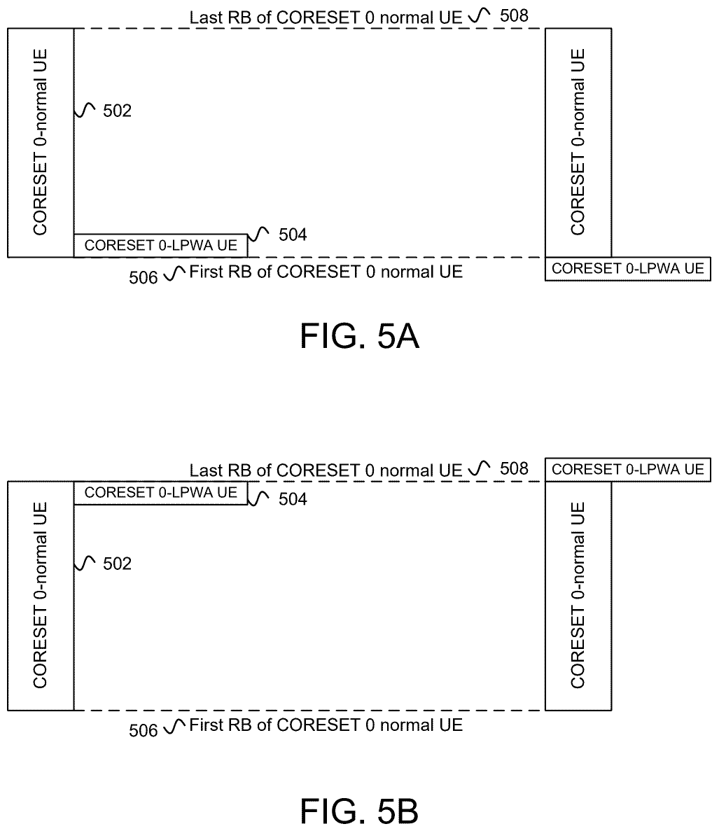

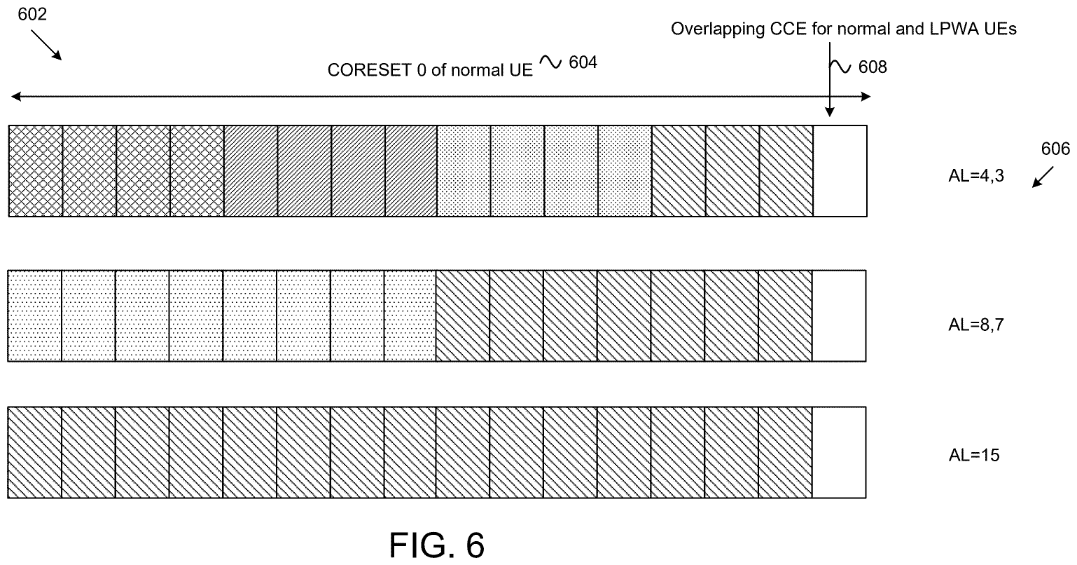

FIGS. 5A and 5B illustrates an example of an LPWA UE operation in accordance with aspects of the present disclosure. In one embodiment, the LPWA-UE, based on determining CORESET 0 of non-LPWA 502, determines its own CORESET 0 504 by assuming its own CORESET 0 RBs start from a reference RB of CORESET 0 of normal UE 502 such as the first 506/last 508 RB of the CORESET 0 of non-LPWA UEs.

For instance, the RBs of CORESET 0 of LPWA-UE 502 start in opposite direction of RBs of CORESET0 of non-LPWA UEs 504. Such a scheme may be desirable particularly if wideband DMRS is used for CORESET 0 of normal UE 502 by avoiding overlap between two CORESETs while using same MIB (in some embodiments, in 5G, CORESET 0 is not assumed to have wideband DMRS, but in future generations that could be a possibility). Alternatively, the normal (non-LPWA) UE may determine its CORESET 0 from that of LPWA UE e.g., by assuming its own CORESET 0 RBs start from a reference RB of CORESET 0 of LPWA UE.

Another way is to fill in the RBs of the gap between the SSB and the CORESET 0 of non-LPWA UEs by CORESET 0 of the LPWA-UEs up to the number of RBs of LPWA-CORESET 0.

For cellBarred/interafreqreselection fields, the corresponding bits might have separate values for LPWA and normal UEs or some of the fields in the MIB may not be applicable to LPWA UEs. The mapping (related to Pdcch-ConfigSIB1 as mentioned above) can be such that either the PDCCH candidates of the LPWA-UE are subset of the PDCCH candidates of the normal UEs, or there is no partial overlap between PDCCH monitoring occasions of the normal UEs and LPWA-UEs. For instance, the CORESET 0 of normal UEs and LPWA-UEs are not overlapping or CORESET 0 of the LPWA UEs is a subset of the CORESET 0 of the normal UEs.

FIG. 6 illustrates an example of control channel candidates in a CORESET in accordance with aspects of the present disclosure. In one embodiment, each rectangle is associated with a CCE, and each pattern represents a PDCCH candidate 602. The number of PDCCH candidates 602 for normal UE could be (1, 3, 1, 1, 1) for AL (3, 4, 7, 8, 15) 606, respectively in case of 1 symbol CORESET 0 for normal UE 604 with 96 RBs to avoid overlap 608 with LPWA-UE candidates, or alternatively, the normal UE assumes the CCE(s) which overlap 608 with CORESET 0 of LPWA UE are punctured for the purpose of PDCCH decoding.

For collision handling of two CORESETs (e.g., CORESET 0 of LPWA-UE and CORESET 0 of normal UE), in some scenarios, having overlapped 608 CORESET 0s may be justified, e.g., in a case of limited system BW in FR1 when e.g., system BW is around 96 RBs and CORESET 0 of normal UEs 604 spans 96 RBs or when there are multiple CORESET 0s (e.g., of other UE types such as LPWA UEs). Alternatively, if CORESET 0 of normal UE 604 is larger than a threshold BW in a particular system BW, it is not expected to have LPWA UEs in that band.

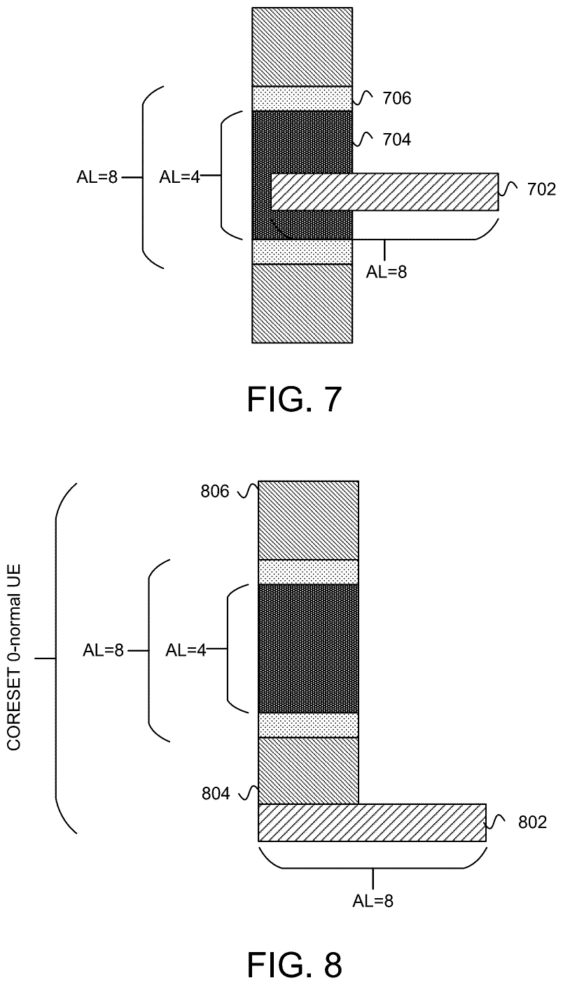

FIG. 7 illustrates an example of a resource collision in accordance with aspects of the present disclosure. As shown in FIG. 7, scheduling a PDCCH candidate for LPWA-UE with AL=8 702 can block scheduling a normal UE in any of the two PDCCH candidates, one with AL=4 704 and one with AL=8 706. Such collisions, if not treated properly, can block scheduling of one or more PDCCH candidates. The situation of overlapping CORESETs is more relevant to CORESET 0 as the CORESET 0 info is provided by the MIB and some pre-determined assumptions; whereas in connected mode, RRC signaling can avoid CORESET overlap to some degree.

FIG. 8 illustrates an example of a CORESET for LPWA-UE in accordance with aspects of the present disclosure. In a first approach, the RB offset is set such that LPWA CORESET 0 802 starts from a reference RB/the start 804 or end 806 of the RBs of the CORESET 0 for normal UEs. For example, the LPWA-UE decodes the MIB, determines the first RB of the non-LPWA CORESET 0, determines the length of the non-LPWA CORESET 0, determines the end of the non-LPWA CORESET 0, and determines the first RB/REG/REG bundle/CCE of the LPWA CORESET 0 based on a reference RB/the last RB/CCE of non-LPWA CORESET 0. Alternatively, the non-LPWA UE may determine its CORESET 0 based on COREET 0 of the LPWA UE following similar steps.

Alternatively, the RB offset should be set such that it avoids overlap with specific candidates/ALs (e.g., AL=16) of normal UEs. The RB offset could be set such that the number of PDCCH candidates or the number of CCEs/RBs/REGs associated with normal UE that is being blocked by CORESET 0/PDCCH candidates of LPWA-UE is minimized.

In some examples, the CCE-to-REG mapping for LPWA UE is non-interleaved (e.g., due to narrow bandwidth—few numbers of CORESET0 RBs), and the CCE-to-REG mapping for normal UE is interleaved. In some examples, the first RB/REG of the LPWA CORESET 0 is aligned in frequency with the lowest RB/REG/REG bundle of a CCE of the normal UE CORESET 0. The CCE of the normal UE CORESET 0 may be a first CCE, last CCE, or a reference CCE. In some examples, the reference CCE may be based on at least one of an indication in the MIB and the SSB.

In some examples, the MIB may indicate at least one of a plurality of RB offsets and the number of symbols for LPWA CORESET 0 (e.g., multiple CORESET 0 positions in frequency and/or duration). The search space 0 associated with the multiple CORESET 0 may have different periodicity. For example, a first CORESET 0 of the multiple CORESET 0 may be preferrable for a LPWA UE of first type, and a second CORESET 0 of the multiple CORESET 0 may be preferrable for a LPWA UE of second type (e.g., coverage extension UE). In some examples, the second CORESET 0 may have a larger number of symbols and may have a larger periodicity than the first CORESET0. In case of overlap between the search space of first CORESET 0 and the second CORESET 0, only the search space corresponding to the second CORESET (e.g., more symbols, higher AL) is assumed to be present. In some examples, the LPWA may select which CORESET 0 from a plurality of CORESET 0s determined/defined by the MIB to monitor based on channel conditions e.g., received signal strength (e.g., RSSI) of SSB.

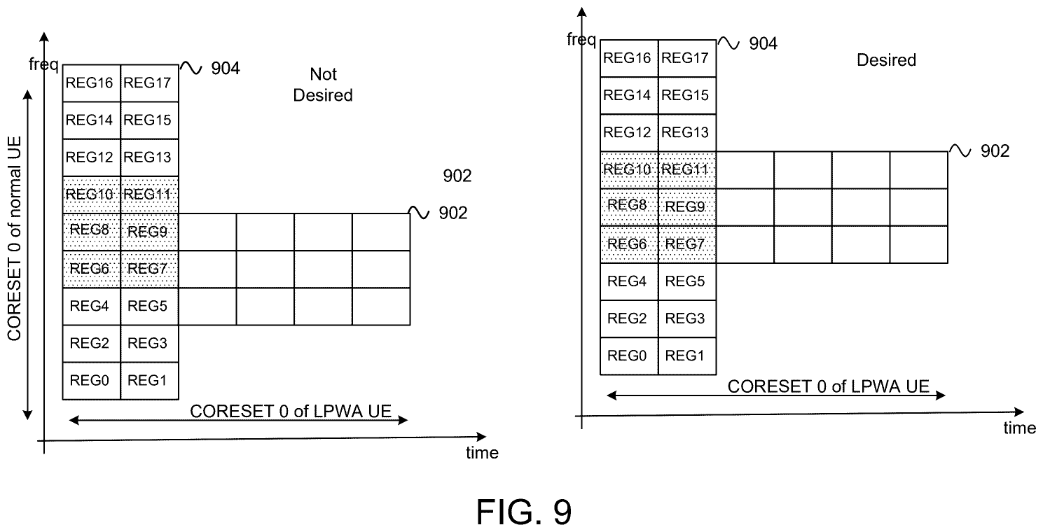

FIG. 9 illustrates an example of CCE to REG mapping in accordance with aspects of the present disclosure. In a second approach, the CCE-to-REG mapping (including hashing function) is determined based on a field in the MIB. At least one of normal or LPWA-UEs determine their CCE-to-REG mapping based on the field in the MIB. One motivation could be to select the CCE-to-REG mapping such that the overlap between the CORESET 0(s) of LPWA UEs 902 and CORESET 0 of non-LPWA UEs 904 is set according to a criteria, e.g., such that the number of CCEs of non-LPWA UEs being blocked by a PDCCH candidate in CORESET 0 of LPWA UEs is minimized.

In an example, the CCE-to-REG mapping of non-LPWA UEs can be set such that their AL=16 candidate avoids overlap with any PDCCH candidate of LPWA UEs. Note the CORESET 0 of non-LPWA UEs may use interleaved CCE-to-REG mapping with a pre-defined interleaving parameters (e.g., L=6, and R=2 in 5G NR with interleaving procedure defined in 5G specifications including TS 38.211). The interleaving procedure can assign REGs/REG bundles to CCEs according to an interleaving formula.

Alternatively, the non-LPWA-UE may determine its interleaving parameter(s) for CCE-to-REG mapping based on a MIB field. For example, the MIB field indicates whether LPWA UEs exist in this cell; or indicates a value, based on which non-LPWA UEs can determine the CORESET 0 (s) for LPWA UEs, and based on determination of CORESET 0 of LPWA UEs, the non-LPWA UEs can determine their interleaving parameters. There could be a shift in the interleaving formula; wherein the shift value can be determined based on the determination of CORESET 0 (s) for LPWA UEs. The MIB field can indicate the RB offset(s) for CORESET 0(s) of LPWA UEs; and the non-LPWA UEs can determine their interleaving parameters based on the RB offset(s) for LPWA UEs.

In a third approach, CCEs of normal UEs overlapping with CCEs of LPWA UEs are not indexed (i.e., removed) for CCE-to-REG mapping for normal UEs. In an example, normal UE determines total number of REGs/REG bundles per CORESET by deducting number of REGs/REG bundles belonging to CCEs which were removed due to collision with REGs/bundles of LPWA UEs. The normal UE may determine the removed CCEs based on RB-offset(s) of LPWA UEs. REG bundle size for normal UE and LPWA UE for CORESET 0 can be fixed in the specifications (e.g., L=6).

In a fourth approach, MIB provides a pattern that indicates in which time occasions, the CORESET 0 of normal UEs would not overlap with CORESET 0 of LPWA-UEs (effectively muting CORESET of LPWA-UEs in some occasions). On those occasions, the LPWA-UEs may not monitor any search space sets or only may monitor a subset of PDCCH candidates.

In an implementation, the REG bundle grid for the LPWA and non-LPWA UEs are the same/aligned (in frequency domain) so that the same DMRS can be used for both UE types and/or handling overlapping REG bundles between the two CORESETS becomes easier (e.g., by removing REG bundles of normal UEs overlapping with REG bundles of LPWA UEs for the sake of CCE-to-REG mapping of normal UEs). CCE-to-REG mapping of at least one of LPWA and normal UE is such that a minimum number of REG bundles/CCEs are overlapped/affected by overlap of the two corresponding CORESET 0s. The scrambling sequence is initialized with the same value for the LPWA and normal UEs (according to the cell-ID).

For normal UE, possible REG bundle sizes can be multiple of that of LPWA UEs. For instance, if the REG bundle size of LPWA UE is 3 RBs (e.g., if number of RBs for the CORESET 0 is 3), for normal UE, it could be 3 or 6 or could be always 6 for CORESET 0 as assumed in 5G. REG bundle size for LPWA UE can be signaled in MIB. In an implementation, the normal UE has a fixed multiple of LPWA-CORESET 0 REG bundle size for its CORESET 0. The concept of sharing/applicability of a MIB message by/to both UE types can be considered for certain subcarrier spacings (e.g., 15 KHz SCS).

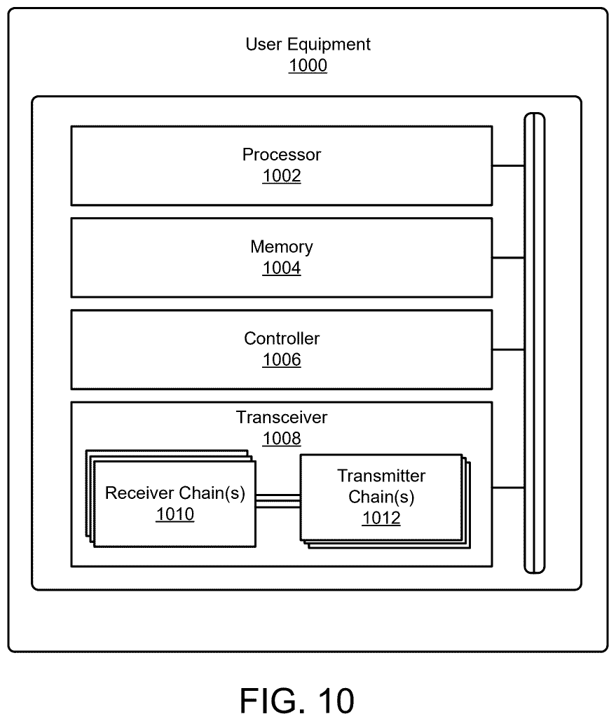

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions when executed by the processor 1002 cause the UE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform one or more of the functions described herein (e.g., executing, by the processor 1002, instructions stored in the memory 1004). For example, the processor 1002 may support wireless communication at the UE 1000 in accordance with examples as disclosed herein. The UE 1000 may determine a plurality of RB offsets associated with a SSB, wherein the plurality of RB offsets comprises at least two RB offsets. The UE 1000 may select at least one of the two RB offsets based on one or more criteria. The UE 1000 may determine resources for monitoring control channel candidates based on the selected at least one of the two RB offsets. The UE 1000 may monitor control channel candidates based on the determined resources.

In one embodiment, the at least two RB offsets comprise a first RB offset and a second RB offset, and wherein the UE 1000 is configured to determine the second RB offset based on the first RB offset. In one embodiment, the first RB offset is associated with a first control region and the second RB offset is associated with a second control region.

In one embodiment, a starting RB of the first control region is based on the first RB offset and a starting RB of the second control region is based on the second RB offset. In one embodiment, the first control region comprises a number of RBs, each RB of the number of RBs is associated with a corresponding RB index that is greater than an RB index of the starting RB of the first control region and the second control region comprises a number of RBs, each RB of the number of RBs is associated with a corresponding RB index that is less than an RB index of the starting RB of the second control region.

In one embodiment, the UE 1000 is configured to monitor the first control region and skip monitoring the second control region. In one embodiment, the two RB offsets comprise a same value.

In one embodiment, the at least two RB offsets comprise a first RB offset, a second RB offset, and a third RB offset and the UE 1000 is configured to determine the second RB offset based on the third RB offset and the first RB offset, wherein the third RB offset comprises an offset with respect to the first RB offset.

In one embodiment, the processor is configured to receive a message corresponding to a reference time associated with the plurality of RB offsets, determine, based on the message, a first time offset with respect to the reference time and a first time duration, determine, based on the first time offset and the first time duration, a second time offset with response to the reference time and a second time duration, and determine the resources for monitoring control channel candidates based on the second time offset and the second duration.

In one embodiment, the second time offset is determined as a function of the first time offset and the first time duration. In one embodiment, the UE 1000 is configured to use the first time offset and the first time duration or the second time offset and the second time duration to determine resources for monitoring control channel candidates based on the SSB.

In one embodiment, the one or more criteria is associated with the SSB, the one or more criteria comprising a signal strength of the SSB or a signal quality of the SSB. In one embodiment, the UE 1000 is configured to receive a message corresponding to a reference time associated with the plurality of RB offsets, determine, based on the message, a plurality of time offsets associated with the reference time and a time duration, wherein the plurality of time offsets comprises a first time offset and a first time duration, a second time offset and a second time duration, or a combination thereof, select the first time offset and the first time duration or the second time offset and the second time duration based on one or more criteria, and determine resources for monitoring control channel candidates based on the selected first time offset and first time duration or second time offset and second time duration.

In one embodiment, the UE 1000 is configured to receive a message comprising a set of fields, wherein a first field of the set of fields indicates a first set of resources, wherein a second field of the set of fields indicates a second set of resources, and wherein the second set of resources is a subset of the first set of resources. The UE 1000 may determine non-overlapping resources of the first set of resources and the second sets of resources. The UE 1000 may determine a set of control channel elements based on the determined non-overlapping resources. The UE 1000 may monitor the determined set of control channel elements.

In one embodiment, the second field indicates a fourth set of resources and wherein the second set of resources comprises overlapping resources of the fourth set of resources and the first set of resources, the first set of resources defining a first control region and the fourth set of resources defining a second control region.

In one embodiment, the UE 1000 is configured to determine the control channel elements based on a set of aggregation levels and a corresponding number of control channel candidates based on the third set of resources.

The controller 1006 may manage input and output signals for the UE 1000. The controller 1006 may also manage peripherals not integrated into the UE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receiving the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the received signal and obtain the transmitted data by reversing the modulation technique applied during transmission of the signal. The receiver chain 1010 may include at least one decoder for decoding and processing the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

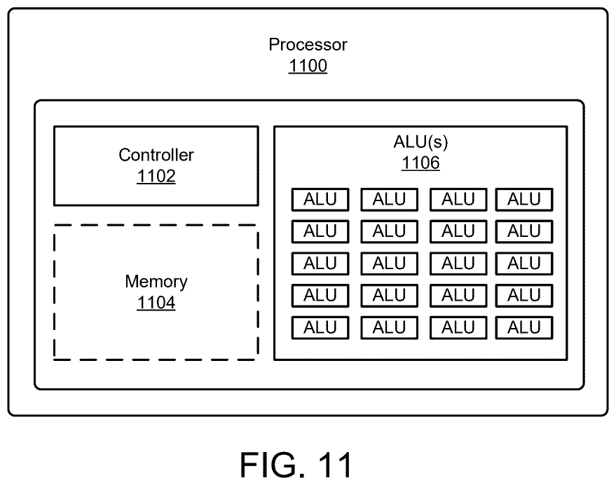

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory address of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, arithmetic logic units (ALUs), and other functional units of the processor 1100.

The memory 1104 may include one or more caches (e.g., memory local to or included in the processor 1100 or other memory, such RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, the controller 1102, and the memory 1104 may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may support wireless communication in accordance with examples as disclosed herein. The processor 1100 may determine a plurality of RB offsets associated with a SSB, wherein the plurality of RB offsets comprises at least two RB offsets. The processor 1100 may select at least one of the two RB offsets based on one or more criteria. The processor 1100 may determine resources for monitoring control channel candidates based on the selected at least one of the two RB offsets. The processor 1100 may monitor control channel candidates based on the determined resources.

In one embodiment, the at least two RB offsets comprise a first RB offset and a second RB offset, and wherein the processor 1100 is configured to determine the second RB offset based on the first RB offset. In one embodiment, the first RB offset is associated with a first control region and the second RB offset is associated with a second control region.

In one embodiment, a starting RB of the first control region is based on the first RB offset and a starting RB of the second control region is based on the second RB offset. In one embodiment, the first control region comprises a number of RBs, each RB of the number of RBs is associated with a corresponding RB index that is greater than an RB index of the starting RB of the first control region and the second control region comprises a number of RBs, each RB of the number of RBs is associated with a corresponding RB index that is less than an RB index of the starting RB of the second control region.

In one embodiment, the processor 1100 is configured to monitor the first control region and skip monitoring the second control region. In one embodiment, the two RB offsets comprise a same value.

In one embodiment, the at least two RB offsets comprise a first RB offset, a second RB offset, and a third RB offset and the processor 1100 is configured to determine the second RB offset based on the third RB offset and the first RB offset, wherein the third RB offset comprises an offset with respect to the first RB offset.

In one embodiment, the processor is configured to receive a message corresponding to a reference time associated with the plurality of RB offsets, determine, based on the message, a first time offset with respect to the reference time and a first time duration, determine, based on the first time offset and the first time duration, a second time offset with response to the reference time and a second time duration, and determine the resources for monitoring control channel candidates based on the second time offset and the second duration.

In one embodiment, the second time offset is determined as a function of the first time offset and the first time duration. In one embodiment, the processor 1100 is configured to use the first time offset and the first time duration or the second time offset and the second time duration to determine resources for monitoring control channel candidates based on the SSB.

In one embodiment, the one or more criteria is associated with the SSB, the one or more criteria comprising a signal strength of the SSB or a signal quality of the SSB. In one embodiment, the processor 1100 is configured to receive a message corresponding to a reference time associated with the plurality of RB offsets, determine, based on the message, a plurality of time offsets associated with the reference time and a time duration, wherein the plurality of time offsets comprises a first time offset and a first time duration, a second time offset and a second time duration, or a combination thereof, select the first time offset and the first time duration or the second time offset and the second time duration based on one or more criteria, and determine resources for monitoring control channel candidates based on the selected first time offset and first time duration or second time offset and second time duration.

In one embodiment, the processor 1100 is configured to receive a message comprising a set of fields, wherein a first field of the set of fields indicates a first set of resources, wherein a second field of the set of fields indicates a second set of resources, and wherein the second set of resources is a subset of the first set of resources. The processor 1100 may determine non-overlapping resources of the first set of resources and the second sets of resources. The processor 1100 may determine a set of control channel elements based on the determined non-overlapping resources. The processor 1100 may monitor the determined set of control channel elements.

In one embodiment, the second field indicates a fourth set of resources and wherein the second set of resources comprises overlapping resources of the fourth set of resources and the first set of resources, the first set of resources defining a first control region and the fourth set of resources defining a second control region.

In one embodiment, the processor 1100 is configured to determine the control channel elements based on a set of aggregation levels and a corresponding number of control channel candidates based on the third set of resources.

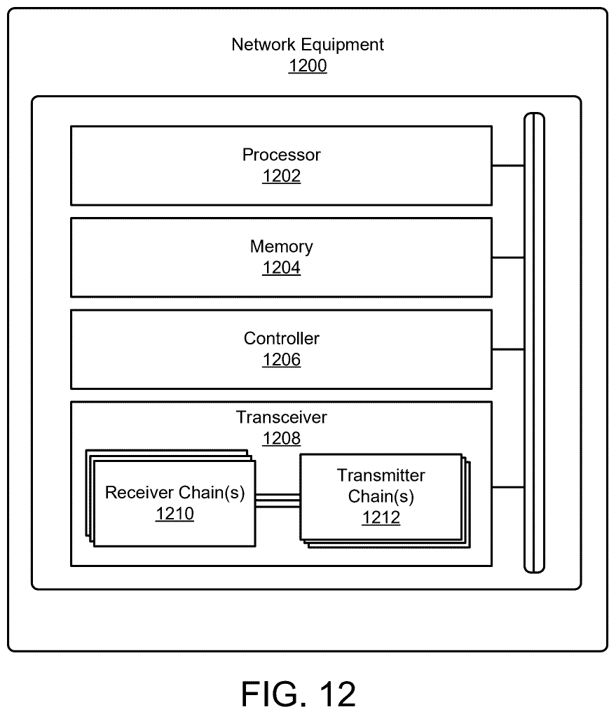

FIG. 12 illustrates an example of a NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform one or more of the functions described herein (e.g., executing, by the processor 1202, instructions stored in the memory 1204). For example, the processor 1202 may support wireless communication at the NE 1200 in accordance with examples as disclosed herein.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas for receiving the signal over the air or wireless medium. The receiver chain 1210 may include at least one amplifier (e.g., a low-noise amplifier (LNA)) configured to amplify the received signal. The receiver chain 1210 may include at least one demodulator configured to demodulate the received signal and obtain the transmitted data by reversing the modulation technique applied during transmission of the signal. The receiver chain 1210 may include at least one decoder for decoding and processing the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

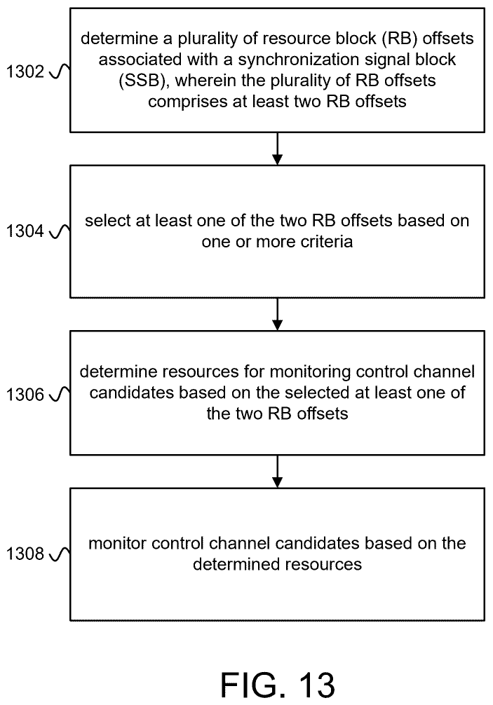

FIG. 13 illustrates a flowchart of a method in accordance with aspects of the present disclosure. The operations of the method may be implemented by a UE as described herein. In some implementations, the UE may execute a set of instructions to control the function elements of the UE to perform the described functions.

At 1302, the method may determine a plurality of RB offsets associated with a SSB, wherein the plurality of RB offsets comprises at least two RB offsets. The operations of 1302 may be performed in accordance with examples as described herein. In some implementations, aspects of the operations of 1302 may be performed by a UE as described with reference to FIG. 10.

At 1304, the method may select at least one of the two RB offsets based on one or more criteria. The operations of 1304 may be performed in accordance with examples as described herein. In some implementations, aspects of the operations of 1304 may be performed by a UE as described with reference to FIG. 10.

At 1306, the method may determine resources for monitoring control channel candidates based on the selected at least one of the two RB offsets. The operations of 1306 may be performed in accordance with examples as described herein. In some implementations, aspects of the operations of 1306 may be performed by a UE as described with reference to FIG. 10.

At 1308, the method may monitor control channel candidates based on the determined resources. The operations of 1308 may be performed in accordance with examples as described herein. In some implementations, aspects of the operations of 1308 may be performed by a UE as described with reference to FIG. 10.

It should be noted that the method described herein describes A possible implementation, and that the operations and the steps may be rearranged or otherwise modified and that other implementations are possible.

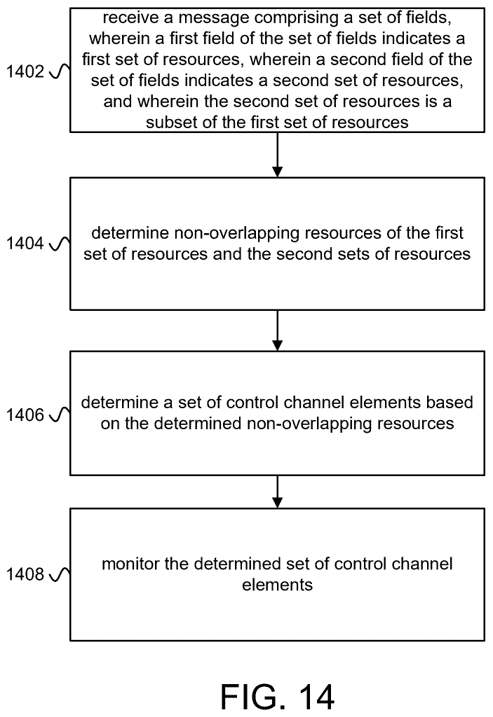

FIG. 14 illustrates a flowchart of a method in accordance with aspects of the present disclosure. The operations of the method may be implemented by a UE as described herein. In some implementations, the UE may execute a set of instructions to control the function elements of the UE to perform the described functions.

At 1402, the method may receive a message comprising a set of fields, wherein a first field of the set of fields indicates a first set of resources, wherein a second field of the set of fields indicates a second set of resources, and wherein the second set of resources is a subset of the first set of resources. The operations of 1402 may be performed in accordance with examples as described herein. In some implementations, aspects of the operations of 1402 may be performed by a UE as described with reference to FIG. 10.

At 1404, the method may determine non-overlapping resources of the first set of resources and the second sets of resources. The operations of 1404 may be performed in accordance with examples as described herein. In some implementations, aspects of the operations of 1404 may be performed by a UE as described with reference to FIG. 10.

At 1406, the method may determine a set of control channel elements based on the determined non-overlapping resources. The operations of 1406 may be performed in accordance with examples as described herein. In some implementations, aspects of the operations of 1406 may be performed by a UE as described with reference to FIG. 10.

At 1408, the method may monitor the determined set of control channel elements. The operations of 1408 may be performed in accordance with examples as described herein. In some implementations, aspects of the operations of 1408 may be performed by a UE as described with reference to FIG. 10.

It should be noted that the method described herein describes A possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
determine a plurality of resource block (RB) offsets associated with a synchronization signal block (SSB), wherein the plurality of RB offsets comprises at least two RB offsets;
select at least one of the two RB offsets based on one or more criteria;
determine resources for monitoring control channel candidates based on the selected at least one of the two RB offsets; and
monitor control channel candidates based on the determined resources.

2. The UE of claim 1, wherein the at least two RB offsets comprise a first RB offset and a second RB offset, and wherein the at least one processor is configured to cause the UE to:
determine the second RB offset based on the first RB offset.

3. The UE of claim 2, wherein:
the first RB offset is associated with a first control region; and
the second RB offset is associated with a second control region.

4. The UE of claim 3, wherein:
a starting RB of the first control region is based on the first RB offset; and
a starting RB of the second control region is based on the second RB offset.

5. The UE of claim 4, wherein:
the first control region comprises a number of RBs, each RB of the number of RBs is associated with a corresponding RB index that is greater than an RB index of the starting RB of the first control region; and
the second control region comprises a number of RBs, each RB of the number of RBs is associated with a corresponding RB index that is less than an RB index of the starting RB of the second control region.

6. The UE of claim 3, wherein the at least one processor is configured to cause the UE to:
monitor the first control region; and
skip monitoring the second control region.

7. The UE of claim 1, wherein the two RB offsets comprise a same value.

8. The UE of claim 1, wherein the at least two RB offsets comprise a first RB offset, a second RB offset, and a third RB offset, wherein the at least one processor is configured to cause the UE to:
determine the second RB offset based on the third RB offset and the first RB offset,
wherein the third RB offset comprises an offset with respect to the first RB offset.

9. The UE of claim 1, wherein the at least one processor is configured to cause the UE to:
receive a message corresponding to a reference time associated with the plurality of RB offsets;
determine, based on the message, a first time offset with respect to the reference time and a first time duration;
determine, based on the first time offset and the first time duration, a second time offset with response to the reference time and a second time duration; and
determine the resources for monitoring control channel candidates based on the second time offset and the second time duration.

10. The UE of claim 9, wherein the second time offset is determined as a function of the first time offset and the first time duration.

11. The UE of claim 9, wherein the at least one processor is configured to cause the UE to use the first time offset and the first time duration or the second time offset and the second time duration to determine resources for monitoring control channel candidates based on the SSB.

12. The UE of claim 1, wherein the one or more criteria is associated with the SSB, the one or more criteria comprising a signal strength of the SSB or a signal quality of the SSB.

13. The UE of claim 1, wherein the at least one processor is configured to cause the UE to:
receive a message corresponding to a reference time associated with the plurality of RB offsets;
determine, based on the message, a plurality of time offsets associated with the reference time and a time duration, wherein the plurality of time offsets comprises a first time offset and a first time duration, a second time offset and a second time duration, or a combination thereof;
select the first time offset and the first time duration or the second time offset and the second time duration based on one or more criteria; and
determine resources for monitoring control channel candidates based on the selected first time offset and first time duration or second time offset and second time duration.

14. A processor for wireless communication, comprising:
at least one controller coupled with at least one memory and configured to cause the processor to:
determine a plurality of resource block (RB) offsets associated with a synchronization signal block (SSB), wherein the plurality of RB offsets comprises at least two RB offsets;
select at least one of the two RB offsets based on one or more criteria;
determine resources for monitoring control channel candidates based on the selected at least one of the two RB offsets; and
monitor control channel candidates based on the determined resources.

15. The processor of claim 14, wherein the at least two RB offsets comprise a first RB offset and a second RB offset, and wherein the at least one processor is configured to cause the UE to:
determine the second RB offset based on the first RB offset.

16. The processor of claim 15, wherein:
the first RB offset is associated with a first control region;
the second RB offset is associated with a second control region.

17. A method of a user equipment (UE), comprising:
determining a plurality of resource block (RB) offsets associated with a synchronization signal block (SSB), wherein the plurality of RB offsets comprises at least two RB offsets;
selecting at least one of the two RB offsets based on one or more criteria;
determining resources for monitoring control channel candidates based on the selected at least one of the two RB offsets; and
monitoring control channel candidates based on the determined resources.

18. A user equipment (UE) for wireless communication, comprising:
at least one memory; and
at least one processor coupled with the at least one memory and configured to cause the UE to:
receive a message comprising a set of fields, wherein a first field of the set of fields indicates a first set of resources, wherein a second field of the set of fields indicates a second set of resources, and wherein the second set of resources is a subset of the first set of resources;
determine non-overlapping resources of the first set of resources and the second sets of resources;
determine a set of control channel elements based on the determined non-overlapping resources; and
monitor the determined set of control channel elements.

19. The UE of claim 18, wherein:
the second field indicates a fourth set of resources;
the second set of resources comprises overlapping resources of the fourth set of resources and the first set of resources;
the first set of resources defining a first control region and the fourth set of resources defining a second control region.

20. The UE of claim 18, wherein the at least one processor is configured to cause the UE to determine the set of control channel elements based on a set of aggregation levels and a corresponding number of control channel candidates based on the third set of resources.
